(19) United States
(12) Patent Application Publication
(10) Pub. No.: US 2003/0147016 A1
(43) Pub. Date: Aug. 7, 2003

(54) LIQUID CRYSTAL DISPLAY WITH TOUCH PANEL

(76) Inventors: Jacob W. Lin, Hsinchu (TW); Chiafu Jeff Nien, Hsinchu (TW); Ching-Sheng Cho, Banchiau City (TW); Szu-Hsien Chen, Hsinchu (TW); Wen-Chi Huang, Chiai (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,004

(22) Filed: Dec. 9, 2002

(30) Foreign Application Priority Data
Dec. 11, 2001 (TW) 90130734

(51) Int. Cl. G02F 1/1335

(52) U.S. Cl. 349/12

(57) ABSTRACT

The invention has modified the conventional LCD structure, wherein a polarizing film is directly coated in the liquid crystal cell instead of the conventional polarizing plate, which is glued on the outer side of the liquid crystal cell. Then, the invention can prevent the direct contact between the polarizing film and the touch panel of film film (FF) type or in film plastic (FP) type. Thus, the touch panel on the LCD panel can adapt various technologies, so that the touch panel of FF type can be used without worrying about the damage on the polarizing film due to the pressure while a point touch is applied on the touch panel. Also and, for the touch panel of FP type, a conductive film can be directly coated on the panel substrate. The invention uses the coating polarizing film as an extraordinary mode (e-mode) polarizer. Also and, an ordinary mode (o-mode) polarizer can also be adapted, so as to expand the large viewing angle in good polarizing effect.

### CROSS REFERENCE TO RELATED APPLICATIONS

This application claims the priority benefit of Taiwan application serial no. 90130734, filed on Nov. 12, 2001.

### BACKGROUND OF INVENTION

1. Field of Invention

The present invention relates to a liquid crystal display (LCD) apparatus. More particularly, the present invention is solution for a mechanical matching issue between a touch panel and a displaying panel. Also and, the invention even can solve an issue of low contrast and narrow viewing angle, caused by the light leakage occurring on the polarizing plate at the different viewing angle.

2. Description of Related Art

The technology used by the conventional touch panel implemented on a LCD mainly is the resistance technology. The main structure is composed of a transparent conductive substrate and a flexible tail. Based on the material being used and the fabrication process, the touch panel is categorized into four categories. The first category is the glass on glass (GG) type touch panel, which is composed of two conductive glass plates and is highly durable for scratching. However, it is the heaviest one with large volume, so that it is rather not suitable for use in the portable information devices. The second category is the film on glass (FG) type touch panel, which is composed of a conductive film at the upper part and a conductive glass at the lower part being glued together. The third category is the film on film (FF) type touch panel, which is formed by gluing two conductive films together with lighter and thinner than the previous two types. The fourth category is the film on plastic (FP) type touch panel, which has the conductive film being directly coated on the panel substrate. The fabrication level is the highest, so that a gluing process and supporting material for the touch panel can be saved. With respect to the light transmission, operation sensitivity, structure property, and fabrication simplicity, the FP type touch panel is better than the other three types of touch panel, and is the most suitable one for use in portable information devices.

Even though the touch panels for FF type and FP type are more suitable for use in the portable information devices, the problem in use is still existing when it is implemented on the LCD. The main reason is that the conventional LCD panel is composed of a liquid cell and a polarizer in combination. The polarizer is glued on the upper side of the liquid crystal cell, and then the touch panel is glued on the top of polarizer. However, the touch panel of FF type or the FO type has a different structure from the LCD panel at the joint part. Since the joint part for the FF type is the conductive film with poor surface hardness, a damage on the polarizer may occur when the user uses the touching pen in touching operation and the touching force from the tip of touch pen will penetrate to the polarizer. As a result, the lifetime of the product is reduced. For the FP type touch panel, it needs to coat the conductive film directly on the display panel substrate. If the displaying panel is implemented with a polarizer, then the fabrication process will be complicate. Therefore, the conventional LCD cannot adapt the touch panels of the two types, which are suitable for use in the portable information devices.

In the structure of a conventional LCD, the polarizer usually causes a difficulty to adapt the new touching panel technology, but also the light leakage on the polarizer at different viewing angle would also cause the low contrast. As a result, it is difficult to widen the viewing angle. The function of the polarizer is to polarize a natural light beam, which has no polarization effect. The vibration direction of the electric field for the natural light beam has been divided into two vectors in perpendicular to each other. The polarizer only allows a component of the light beam, which has a specific vibration direction in electric field, to pass. The other component with other vibration direction is absorbed. After the light beam passes the polarizer, the vibration direction of the electric field is approaching into the specific direction and become a linear polarization light beam. If two polarizers with the polarization directions in difference by 90° are used, and a liquid crystal layer is disposed between them, and an external electric field is used to control the twist angle of the liquid crystal molecules for changing the light traveling direction, then the bright and dark states on the panel can be controlled, so as to achieve the function to display the image. The current polarizer suitable for use in LCD usually uses the PVA (poly-vinyl-alcohol) film as the substrate absorbing with the dual-color polarizing factors of iodo-group or dye material, to perform an elongation process on the single axis. After that, a TAC (tri-acetate cellulose) film and a surface protection film cover it from top and bottom to improve the stability. By this method to fabricate the polarizer, the polarizing molecules can be aligned into a linear structure. The aligning direction is set to be parallel to the common-axis or c-axis, so that a component of the incident light having the vibration direction perpendicular to the c-axis can pass, that is, the transmitting axis is perpendicular to the c-axis and becomes an o-mode polarizer. Even though the polarizer can only allow the light beam having vibration on the transmitting axis to pass, however, it should be at a specific viewing angle, at which the light not on the transmission axis can be completely absorbed. As a result, when the viewing angle is gradually changed, a light leakage will occur on the polarizer, causing the problems of a decrease of the contrast for the displaying screen and a narrow viewing angle.

In Japanese patent JP09090316, a touch panel associating with the LCD has been disclosed. The touch panel is the FG type and is directly coupled with LCD panel. The structure sequentially is a touch panel, a polarizer, an upper substrate of the displaying panel, a liquid crystal layer, a lower substrate of the displaying panel. This patent can improve the issue of low contrast caused by the exerting pressure while a point touch is operated on the touch panel. However, it still cannot adapt the FF type touch panel.

In U.S. Pat. No. 6,049,428, the liquid crystal material is mixed with organic dye material to replace the rather conventional polarizer with iodo-group/PVA. The polarizer fabricated by this manner has the transmitting axis parallel to the c-axis. This is opposite to the o-mode polarizer but is the e-mode polarizer.

In U.S. Pat. No. 6,174,394, the liquid crystal material having been mixed with organic dye material is dissolved by a solution, so that it uses a Mayer rod or a roller to coat and to align simultaneously on the substrate. After baking and curing, a polarizing film is formed. The thickness is thinner than the rather conventional polarizer and is compatible with o-mode in the better polarization effect.

### SUMMARY OF INVENTION

It is an objective of the invention to provide a liquid crystal display apparatus, which can adapt for use with all types of touch panel.

It is an objective of the invention to provide a liquid crystal display apparatus, which can adapt for use with all types of touch panel. Also and, when the new type of touch panel is used, the lifetime and displaying quality of the liquid crystal display apparatus are not affected.

It is an objective of the invention to provide a liquid crystal display apparatus, which can improve the issue of low contrast caused by light leakage on the polarizer in different viewing angles, so as to provide a better displaying quality.

It is an objective of the invention to provide a liquid crystal display apparatus, which can have the product in lighter and thinner structure.

As embodied and broadly described herein, the invention has modified the conventional LCD structure, wherein a polarizing film is directly coated in the liquid crystal cell instead of the conventional polarizing plate, which is glued on the outer side of the liquid crystal cell. Then, the invention can prevent the direct contact between the polarizing film and the touch panel of film film (FF) type or in film plastic (FP) type. Thus, the touch panel on the LCD panel can adapt various technologies, so that the touch panel of FF type can be used without much worry about the damage on the polarizing film due to the pressure while a point touch is applied on the touch panel. Also and, for the touch panel of FP type, a conductive film can be directly coated on the panel substrate. The invention uses the coating polarizing film as an extraordinary mode (e-mode) polarizer. Also and, an ordinary mode (o-mode) polarizer can also be adapted, so as to expand the large viewing angle in good polarizing effect.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross-sectional view, schematically illustrating a liquid crystal display with a touch panel, according to a first embodiment of the present invention;

FIG. 2 is a cross-sectional view, schematically illustrating a liquid crystal display with a touch panel, according to a second embodiment of the present invention;

FIG. 3 is a cross-sectional view, schematically illustrating a liquid crystal display with a touch panel, according to a third embodiment of the present invention;

FIG. 4 is a cross-sectional view, schematically illustrating a liquid crystal display with a touch panel, according to a fourth embodiment of the present invention;

FIG. 5 is a cross-sectional view, schematically illustrating a FF type touch panel;

FIG. 6 is a cross-sectional view, schematically illustrating a FP type touch panel; and

FIGS. 7A-7C are drawings, schematically illustrating the implement of the polarizer in o-mode and e-mode.

### DETAILED DESCRIPTION

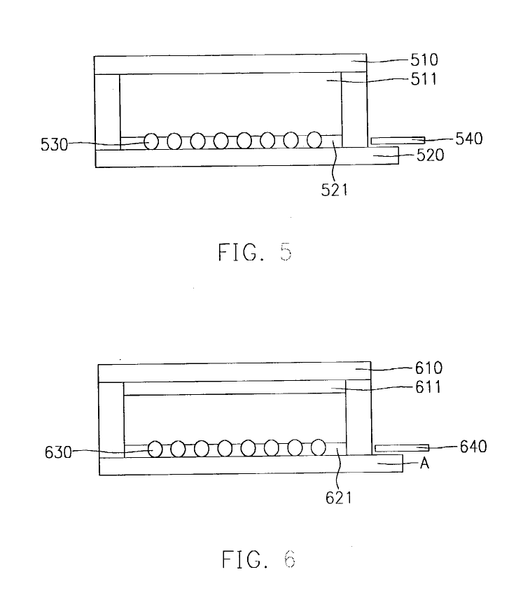

In order to adapt the technology for the FF or FP touch panels, there is no the other optical devices existing between the displaying panel and the touch panel. As shown in FIG. 5, the FF type touch panel includes upper and lower conductive films 510, 520, conductive layers 511 and 521, a flexible tail 540, and spacer points 530. The touch panel is directly glued on the outer side of the displaying panel. For the conventional LCD, the outpost of the displaying panel is the polarizing device, so that the touch panel and the polarizer are directly adhered. This touch panel is the film substrate, not like the conductive glass with better capability for scratching resistance. As a result, when the user uses the touching pen to operate a point touch, it would cause an abrasion on the polarizer and reduce the lifetime of the product. Also and, as shown in FIG. 6, a FP type touch panel is disclosed. The FF type touch panel includes an upper conductive film 610, conductive layers 611 and 621, a flexible tail 640, spacer points 630, and a conductive film directly coated on the surface of the displaying panel A. Since the lower substrate of the touch panel is removed, and the conductive layer is directly coated on the outer surface of the substrate of the displaying panel, it is then difficult to adapt the FP type touch panel due to the structure and the fabrication process with respect to the conventional LCD, which has the polarizer being disposed on the outer side of the displaying panel. In order to solve these kinds of problems, it is necessary to modify the structure of the conventional LCD. The polarizer originally disposed on the outer side of the displaying panel has to be removed, so as to be capable of adapting the FF type touch panel without concerning about the damage on the polarizer due to the point touch. Also and, it needs not worry about the fabrication that the lower substrate film of the touch panel is removed, so as to directly coat the conductive film on the panel substrate. After the polarizer on the outer side of the displaying panel is removed, the simplified structure has the polarizer formed on the inner side of the panel by the coating manner. The film type polarizer uses the liquid crystal material, such as the aromatic lyotropic liquid crystal in being added with the organic dye, such as the anthracene sulfonate etc. After being dissolved by the solvent, a mechanical coating process is performed. For example, a Mayer rod is used to coat and align on the inner side of the substrate, whereby the molecules are aligned to a specific direction, so as to absorb the light beam has the vibration direction on the desired direction. After baking for curing, a polarizing film can be formed. For the polarizing film formed by the coating manner, the thickness is 1 to 100 microns when it just has been coated but before baking for curing. After backing for curing, the accomplished polarizing film has the thickness of 0.1 to 1 microns. This can have been better satisfying to the requirement of light and thin properties than that of the conventional polarizer by gluing from outer side. Also and, it can be chosen to form at inner side or the outer side. As a result, it can associate with the type of the touch panel, the LCD structure can be changed to dispose the polarizer at the inner side of the displaying panel. The basic structure for this structure is that the touch panel is directly disposed on the outer side of the substrate of the displaying panel, in which the structure at the inner side of the substrate includes three different types. (1) The polarizing film is coated between the electrode layer and the aligning layer. (2) The polarizing film is coated between the displaying panel substrate and the electrode layer. (3) Since the polarizing film by itself is formed by the polarizing molecules being aligned, the polarizing molecules can be aligned to a certain direction. As a result, the polarizing film can replace the aligning film to cause the polarizing molecules to form along a pre-tilt angle. This, it can take place of the aligning layer

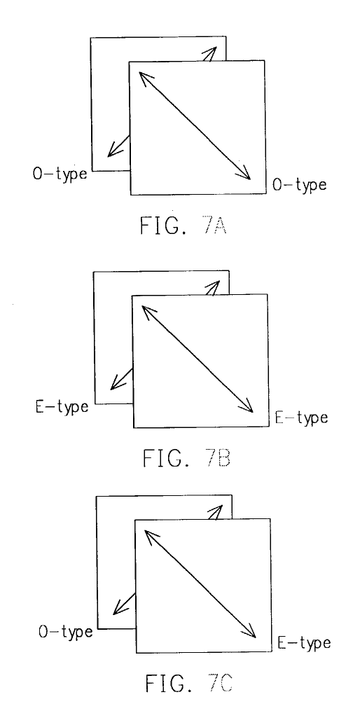

The conventional LCD with the touch panel is using two o-mode polarizers to set their transmitting axis to be perpendicular to each other in combination, as shown in FIG. 7a. When the incident light is perpendicularly incident, the incident light will be completely absorbed, resulting in a zero transmission. However, when the incident light start to be incident by a tilt incident angle, that is, the viewing angle starts to change, then the phenomenon of light leakage occurs, and the phenomenon of light leakage increases as the incident angle increases. In this situation, the best displaying contrast is only at the viewing angle by zero degree. In the present invention, the polarizing molecules in the polarizing film has formed a cylindrical-like alignment, so that it can also block the light which is perpendicular to the common-axis, and then only allow the light which is parallel to the common-axis, to transmit. The e-mode polarizing device is obtained. If two e-mode polarizing films are used as shown in FIG. 7b, a light leakage is still occurring as the viewing angle is changed. However, the different from the o-mode polarizer is that the quantity of the light leakage will decrease as the incident angle increases. In other words, when the light is perpendicular incident, the quantity of light leakage is at maximum. So, in combination the properties for the o-mode and the e-mode, as shown in FIG. 7c, no matter whether the incident light is perpendicular incident or incident by a large incident angle, the quantity of light leakage can be reduced. As a result, the quality of displaying contrast can be improved and therefore the viewing angle range for the displaying panel can be effective widened.

Since the conventional polarizer needs to use the PVC as the substrate, the regions with higher or lower operational temperature may produce retraction or expansion due to the PVC is sensitivity to the temperature, resulting in deterioration of the polarizer. For polarizing film by the coating manner, the polarizing material is directly coated on the panel substrate without using the PVC substrate. As a result, the temperature variation will not cause the non-uniform displaying. The suitable range of operational temperature is wider.

In the LCD apparatus of the invention, the upper polarizing device is implemented on the inner side of the displaying panel by the coating manner, then the outer side of the displaying panel can be directly implemented with the FF type touch panel and the FP type touch panel. The LCD apparatus can be a reflective type LCD, wherein only one polarizing plate is needed. In addition, it can be a half-transmitting LCD, in which the inner side or the outer side of the lower substrate can be implemented with the polarizing device by the coating manner. Or, the polarizing device can be glued on the outer side of the displaying panel to achieve the on/off function.

Embodiment 1

FIG. 1 is a cross-sectional view, schematically illustrating a liquid crystal display with a touch panel, according to a first embodiment of the present invention. The LCD apparatus 100 includes an upper substrate 110, a lower substrate 120, a frame sealant 130, a liquid crystal layer 140 and a touch panel 500.

The outer side of the upper substrate 110 is implemented with a touch panel 500. The structure of the touch panel 500 is as shown in FIG. 5 including the upper and lower conductive films 510, 520, a flexible tail 540, and spacer points 530. The touch panel 500 can be directly glued on the outer side of the upper substrate, so as to serve as an input interface by a touching manner. In addition, the touch panel in FIG. 6 can be adapted, in which the lower conductive film is removed, but a conductive layer is directly coated on the outer side of the displaying panel substrate A, wherein in this embodiment the layer A is the upper substrate 110 of the display panel. And then, the upper conductive film 610 and the spacer points 630 are implemented to form the touch panel.

The upper substrate 110 uses a transparent glass or a transparent plastic film as the substrate 111. The electrode layer 112 is implemented on the inner side surface to have a plurality of columnar transparent electrodes by, for example, indium tin oxide film. The polarizing film 113 is implemented on the electrode layer. The method to form the polarizing film 113 can be, for example, as follows: the liquid crystal molecules and organic dye are dissolved into the solvent. Then, the spin coating process or the May roller printing process are performed to coat and align the polarizing material on the electrode layer 112, and then a baking process for curing and dehydrating, so as to form the polarizing film. The present invention uses the May roller printing method to coat and align the polarizing film to form a polarizing film with a thickness of 0.4 microns. The molecules of the polarizing film forms the e-mode polarizing film, used to control polarizing state of the light beam. The aligning layer 114 is disposed on the polarizing film 113, so as to achieve the purpose to pre-tilt the molecules.

The lower substrate 120 uses a transparent glass or a transparent plastic film as the substrate 121. The electrode layer 122 is implemented on the inner side surface to have a plurality of columnar transparent electrodes by, for example, indium tin oxide film. The aligning layer 124 is formed on the electrode layer 122 to achieve the purpose to pre-tilt the liquid crystal molecules. The polarizing film 123 is glued on the outer surface of the lower substrate 121 to have the o-mode polarizer for controlling the polarization state of the light. The method to form the polarizing device can be formed by the spin coating process or the May roller printing process to coat and align the polarizing material on the outer side of the lower substrate 121. Then, a baking process for curing is performed to form the e-mode polarizing device with a thickness of 0.4 microns.

The frame sealant 130 is disposed between the upper substrate 110 and the lower substrate 120 to form a free space. The liquid crystal layer 140 is disposed in the free space to form a LCD cell. The liquid crystal used in the embodiment is the super twisted Nematic (STN) liquid crystal.

Embodiment 2

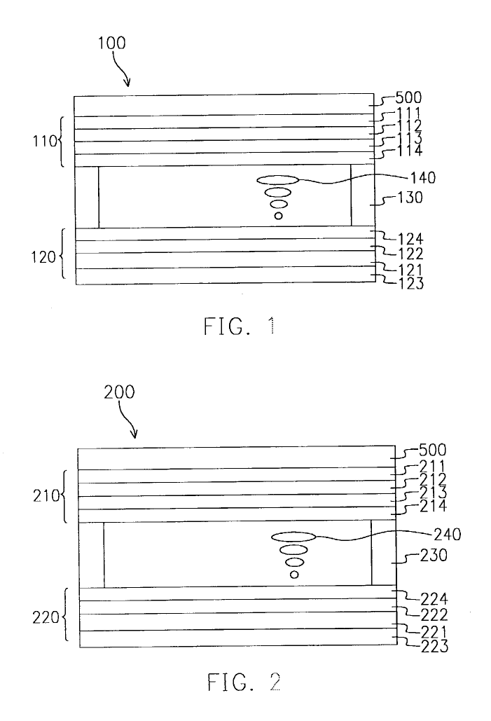

FIG. 2 is a cross-sectional view, schematically illustrating a liquid crystal display with a touch panel, according to a second embodiment of the present invention. The LCD apparatus 200 includes an upper substrate 210, a lower substrate 220, a frame sealant 230, a liquid crystal layer 240 and a touch panel 500.

The panel 500 is disposed on the outer side of the upper substrate 310. The touch panel 500 is directly glued on the outer side of the upper substrate 310, so as to serve as an input interface by the touch manner. The structure of the touch panel 500 can be the one as shown in FIG. 5 or FIG. 6.

The structure of the upper substrate 210 includes a transparent substrate 211, of which an electrode layer 212 is disposed on the inner surface. The polarizing film 213 is coated on the electrode layer to have an e-mode polarizing film. The phase difference film 215 is disposed on the polarizing film 213, so as to correct the optical path for the outgoing light. The aligning layer 214 is disposed on the phase difference film 215.

The structure of the lower substrate 220 includes a transparent substrate 221, of which the electrode layer 222 is disposed on the inner surface. The aligning layer 224 is disposed on the electrode layer 222. The polarizer 223 is an o-mode polarizer, which is glued on the outer side surface of the lower substrate 221. The polarizing device can also use the coating method to form an e-mode polarizing film.

The frame sealant 230 is disposed between the upper substrate 210 and the lower substrate 220 to form a free space. The liquid crystal layer 240 is disposed in the free space to form a LCD cell.

Embodiment 3

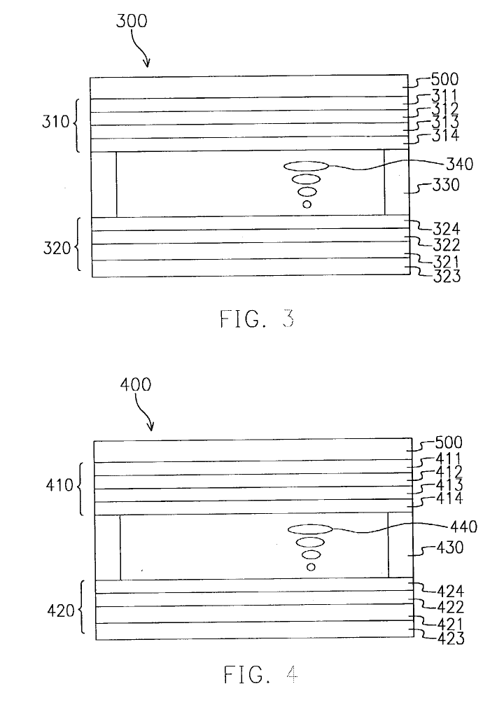

FIG. 3 is a cross-sectional view, schematically illustrating a liquid crystal display with a touch panel, according to a third embodiment of the present invention. The LCD apparatus 300 includes an upper substrate 310, a lower substrate 320, a frame sealant 330, a liquid crystal layer 340 and a touch panel 500.

The panel 500 is disposed on the outer side of the upper substrate 310. The touch panel 500 is directly glued on the outer side of the upper substrate 310, so as to serve as an input interface by the touch manner. The structure of the touch panel 500 can be the one as shown in FIG. 5 or FIG. 6.

The structure of the upper substrate 310 includes a transparent substrate 311, of which an electrode layer 312 is disposed on the inner surface. The polarizing film 313 is coated on the electrode layer to have an e-mode polarizing film. The phase difference film 215 is disposed on the polarizing film 213, so as to correct the optical path for the outgoing light. The aligning layer 314 is disposed on the phase difference film 315.

The structure of the lower substrate 320 includes a transparent substrate 321, of which the electrode layer 322 is disposed on the inner surface. The polarizing film 323 film is coated on the electrode layer 322. The aligning layer 324 is disposed on the polarizing film 323.

The frame sealant 330 is disposed between the upper substrate 310 and the lower substrate 320 to form a free space. The liquid crystal layer 340 is disposed in the free space to form a LCD cell.

Embodiment 4

FIG. 4 is a cross-sectional view, schematically illustrating a liquid crystal display with a touch panel, according to a fourth embodiment of the present invention. The LCD apparatus 400 includes an upper substrate 410, a lower substrate 420, a frame sealant 430, a liquid crystal layer 440 and a touch panel 500.

The panel 500 is disposed on the outer side of the upper substrate 410. The touch panel 500 is directly glued on the outer side of the upper substrate 310, so as to serve as an input interface by the touch manner. The structure of the touch panel 500 can be the one as shown in FIG. 5 or FIG. 6.

The structure of the upper substrate 410 includes a transparent substrate 411, of which an electrode layer 412 is disposed on the inner surface. The polarizing film 413 is coated on the electrode layer to have an e-mode polarizing film. The aligning layer 414 is disposed on polarizing film 413.

The structure of the lower substrate 420 includes a transparent substrate 421, of which the electrode layer 422 is disposed on the inner surface. The polarizing film 423 film is coated on the electrode layer 422. The aligning layer 424 is disposed on the polarizing film 423.

The frame sealant 430 is disposed between the upper substrate 410 and the lower substrate 420 to form a free space. The liquid crystal layer 440 is disposed in the free space to form a LCD cell.

The present invention can be applied to various types of LCD, including TN-LCD, STN-LCD, TFT-LCD, polymer dispersing LCD, or ECB LCD.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A liquid crystal display (LCD), comprising:
a touch panel, to serving as an input interface;
an upper substrate, implemented with an electrode layer and an aligning layer inside, wherein the touch panel is disposed on an outer side of the upper substrate;
a polarizing device, disposed on the inner side of the upper substrate, for polarizing an incident light;
a lower substrate, implemented with an electrode layer and an aligning layer inside;
a liquid crystal layer, disposed between the upper substrate and the lower substrate; and
a frame sealant, enclosing the liquid crystal layer.

2. The LCD of claim 1, wherein the touch panel comprises an upper conductive substrate, a lower conductive substrate, a conductive layer coated on the substrates, and a flexible tail.

3. The LCD of claim 2, wherein the upper and lower conductive substrates of the touch panel includes conductive films.

4. The LCD of claim 2, wherein the upper conductive substrate of the touch panel is a conductive film, the lower conductive substrate is directly coated on an outer surface of the upper substrate of the LCD.

5. The LCD of claim 1, wherein the polarizing device includes a liquid crystal material mixed with an organic dye material by coating, and a thickness is 0.2-1 microns.

6. The LCD of claim 5, wherein the polarizing device is located between the electrode layer and the aligning layer.

7. The LCD of claim 5, wherein the polarizing device is located between the substrate and the electrode layer.

8. The LCD of claim 5, wherein the polarizing device has a transmitting axis which is parallel to a common-axis, which is an e-mode polarizer.

9. The LCD of claim 5, further comprising a phase different film, disposed a inner side of the polarizing device.

10. The LCD of claim 5, further comprising a polarizer at inner side of the lower substrate.

11. The LCD of claim 10, wherein the polarizer is located between the lower substrate and the aligning layer.

12. The LCD of claim 10, wherein the polarizer is located between the electrode layer and the aligning layer.

13. The LCD of claim 1, further comprising a polarizer at outer side of the lower substrate.

14. The LCD of claim 13, wherein the polarizer has a transmitting axis which is parallel to a common-axis, which is an e-mode polarizer.

15. The LCD of claim 13, wherein the polarizer has a transmitting axis which is perpendicular to a common-axis, which is an o-mode polarizer.

16. A liquid crystal display (LCD), comprising:
a touch panel, to serving as an input interface;
an upper substrate, implemented with an electrode layer and a polarizing film inside, wherein the touch panel is disposed on an outer side of the upper substrate;
a lower substrate, implemented with an electrode layer and a polarizing film inside;
a liquid crystal layer, disposed between the upper substrate and the lower substrate; and p1 a frame sealant, enclosing the liquid crystal layer.

17. The LCD of claim 16, wherein the touch panel comprises an upper conductive substrate, a lower conductive substrate, a conductive layer coated on the substrates, and a flexible tail.

18. The LCD of claim 17, wherein the upper and lower conductive substrates of the touch panel includes conductive films.

19. The LCD of claim 17, wherein the upper conductive substrate of the touch panel includes conductive film, the lower conductive substrate of the touch panel is directly coated on an outer surface of the upper substrate of the LCD.

20. The LCD of claim 16, wherein the polarizing device includes a liquid crystal material mixed with an organic dye material by coating, and a thickness is 0.2-1 microns.

21. The LCD of claim 16, wherein the polarizing device on the substrate includes a liquid crystal material mixed with an organic dye, and is coated on the electrode layer by May roller coating and aligning, so as to simultaneously have the functions of a polarizing device and an aligning layer.

22. The LCD of claim 21, wherein the polarizing device has a transmitting axis perpendicular to a common-axis, to be an e-mode polarizing device.

23. The LCD of claim 16, wherein the polarizing device on the lower substrate includes a liquid crystal material mixed with an organic dye material by coating, and a thickness is 0.2-1 microns.

24. The LCD of claim 16, wherein the polarizing device on the substrate includes a liquid crystal material mixed with an organic dye, and is coated on the electrode layer by May roller coating, so as to simultaneously have the functions of a polarizing device and an aligning layer.

25. The LCD of claim 24, wherein the polarizing device has the transmitting axis perpendicular to a common-axis, to be an e-mode polarizer.
